(19) United States
(12) Patent Application Publication
(10) Pub. No.: US 2017/0153406 A1
(43) Pub. Date: Jun. 1, 2017

(54) MODULAR EQUIPMENT RAIL AND CABLE GUIDE SYSTEMS FOR FIBER OPTIC EQUIPMENT

(71) Applicant: Corning Optical Communications LLC, Hickory, NC (US)

(72) Inventor: Diana Rodriguez, Fort Worth, TX (US)

(21) Appl. No.: 15/365,025

(22) Filed: Nov. 30, 2016

Related U.S. Application Data
(60) Provisional application No. 62/261,023, filed on Nov. 30, 2015.

(51) Int. Cl. G02B 6/44; G02B 6/38

(52) U.S. Cl. CPC G02B 6/4452; G02B 6/3897

(57) ABSTRACT

Disclosed are solutions for toollessly and modularly attaching module, tray, and cable routing guides to fiber optic equipment trays and hardware. Solutions consistent with the present invention also streamline the design of the tray and module rail guide system to reduce overall part counts that were formerly associated with non-ambidextrous solutions.

### CROSS-REFERENCE TO RELATED APPLICATION

This application claims the benefit of priority under 35 U.S.C.§119 of U.S. Provisional Application Ser. No. 62/261,023 filed on Nov. 30, 2015 the content of which is relied upon and incorporated herein by reference in its entirety.

### BACKGROUND

Field

The technology of the disclosure relates to fiber optic hardware and, more particularly, to fiber optic hardware chassis with interchangeable, modular tray and module guide hardware.

Technical Background

Benefits of optical fiber include extremely wide bandwidth and low noise operation. Because of these advantages, optical fiber is increasingly being used for a variety of applications, including but not limited to broadband voice, video, and data transmission. Fiber optic networks employing optical fiber are being developed and used to deliver voice, video, and data transmissions to subscribers over both private and public networks. These fiber optic networks often include separated connection points linking optical fibers to provide “live fiber” from one connection point to another connection point. In this regard, fiber optic equipment is located in data distribution centers or central offices to support interconnections. For example, the fiber optic equipment can support interconnections between servers, storage area networks (SANs), and other equipment at data centers. Interconnections may be supported by fiber optic patch panels or modules.

The fiber optic equipment is customized based on the application and connection bandwidth needs. The fiber optic equipment is typically included in housings that are mounted in equipment racks to optimize use of space. The data rates that can be provided by equipment in a data center are governed by the connection bandwidth supported by the fiber optic equipment. The bandwidth is governed by the number of optical fiber ports included in the fiber optic equipment and the data rate capabilities of a transceiver connected to the optical fiber ports. When additional bandwidth is needed or desired, additional fiber optic equipment can be employed or scaled in the data center to increase optical fiber port count. However, increasing the number of optical fiber ports can require more equipment rack space in a data center. Providing additional space for fiber optic equipment increases costs. A need exists to provide fiber optic equipment that provides a foundation in data centers for migration to high density patch fields and ports and greater connection bandwidth capacity to provide a migration path to higher data rates while minimizing the space needed for such fiber optic equipment.

### SUMMARY

The application discloses a tray for mounting fiber optic equipment, the tray comprises a base for supporting a plurality of BASE-8 fiber optic equipment. The tray also comprises one or more support rails of the base for movably mounting the tray in a fiber optic equipment chassis. The tray further comprises a plurality of equipment support rails of the base for movably mounting the plurality of BASE-8 fiber optic equipment to the tray.

Additional features and advantages will be set forth in the detailed description which follows, and in part will be readily apparent to those skilled in the art from the description or recognized by practicing the embodiments as described in the written description and embodiments hereof, as well as the appended drawings.

It is to be understood that both the foregoing general description and the following detailed description are merely exemplary, and are intended to provide an overview or framework to understand the nature and character of the embodiments.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIGS. 1A and 1B illustrate perspective views of an exemplary cable routing guide and said exemplary cable routing guide connected to an equipment tray, respectively, in accordance with certain disclosed embodiments;

FIGS. 2A and 2B illustrate features associated with equipment tray for toollessly attaching the tray and module rail guides, consistent with certain disclosed embodiments;

FIGS. 3A and 3B illustrate perspective and side views, respectively, of an cable routing feature toollessly attached to an equipment tray, according to certain disclosed embodiments;

FIGS. 4A and 4B illustrate perspective top-down and bottom-up views, respectively, of an exemplary mounting rail for use on a tray, in accordance with certain disclosed embodiments;

FIGS. 5A and 5B illustrate perspective and side views, respectively, of an exemplary mounting rail, toollessly attached to an equipment tray, consistent with certain disclosed embodiments;

FIGS. 6A and 6B illustrate perspective views of an exemplary left tray rail and module mounting rails, toollessly attached to left tray rail, consistent with certain disclosed embodiments;

FIGS. 6C and 6D illustrate perspective views of an exemplary right tray rail and module mounting rails, toollessly attached to right tray rail, consistent with certain disclosed embodiments;

FIGS. 7A and 7B illustrate perspective views of an exemplary left and right tray rails, respectively, with module mounting rails toollessly attached to the respective left and right tray rails and toollessly connected to the equipment tray, consistent with certain disclosed embodiments; and

FIG. 8 is a perspective view of an equipment tray adapted to support six (6) fiber optic modules (or panels) per tray, in accordance with certain disclosed embodiments.

### DETAILED DESCRIPTION

The application discloses BASE-8 modules, fiber optic panel assemblies, and hybrid fiber optic modules for mounting in equipment trays that can be mounted in a movable fashion to a chassis. The assemblies disclosed provide the ability to easily and quickly migrate an optical network between duplex transmission and 8-fiber parallel transmission. The BASE-8 configurations are contrary to the installed BASE-12 optical networks that are widely deployed. Further, the BASE-8 components and assemblies can improve fiber utilization rates when requiring quick and easy migration path between duplex and parallel transmission in an optical network.

Conventional solutions include replacing the current MPO/LC breakout duplex modules with MPO panels/modules when converting to 8-fiber links for parallel transmission. However, there is a need for flexibility to convert back to 2-fiber links as needed when network requirements change, such as new lower bandwidth equipment placed in cabinet, or a new technology evolving that only requires 2-fiber duplex connectivity. Hence, the ability to easily convert between duplex and 8-fiber parallel transmission systems is desired and not currently available with conventional networks. One embodiment is directed to tray for mounting fiber optic equipment having a BASE-8 configuration. For instance, the fiber optic equipment having the BASE-8 configuration could be a module, a panel assembly, a hybrid module, or other suitable fiber optic equipment.

As used herein, BASE-8 means the component supports transmission of eight optical channels and connects with 8-fiber connectors, not 12-fiber connectors. Consequently, all of the optical channels may be used for migrating between duplex and parallel transmission without having unused optical fibers. The concepts are depicted with 8-fiber ports such as MPO ports and single fiber ports such as LC ports that support single fiber connectors. Fiber optic equipment and assemblies disclosed may be secured and supported in trays, and the trays may be secured and supported in a chassis. Further, the fiber optic equipment may optionally move relative to the trays when attached thereto. Likewise, the trays may optionally move relative to the chassis when attached thereto.

This disclosure is directed to pre-terminated solutions based around using units of 8-fibers in connectors and adapters to match-up with the channels required for an 8-fiber parallel transceiver. This is in contrast to the conventional 12- and 24-fiber base solutions used in optical networks today. Included in this disclosure are trunk cables with 8-fiber units, MPO connectors or other suitable connector only populated with 8-fibers, and BASE-8 fiber optic equipment such as MPO to LC fiber optic modules, fiber optic panel assemblies and hybrid fiber optic modules.

Generally speaking, a module will include an enclosure having an internal chamber, whereas a panel assembly will not have an enclosure. A fiber harness is typically installed into the internal chamber of the module for protecting the same. Panel assemblies may be used for optical connection such as a fiber optic panel assembly comprising a front panel disposed at a front end with a linear array of fiber optic adapters arranged in a width direction in the front panel in a BASE-8 configuration. Further, the BASE-8 fiber optic equipment such as the fiber optic panel assembly or module may compactly mount into a tray using 1/6 of the tray width or less. In another embodiment, the fiber optic panel assembly has a first and second multi-fiber adapter disposed at a front end of the fiber optic panel assembly and at least one pass-through channel at the rear side. Another piece of fiber optic equipment is the hybrid fiber optic module that supports connections for eight LC connections and an 8-fiber MPO connection at the front end, and which provides a quick and easy migration node in the network.

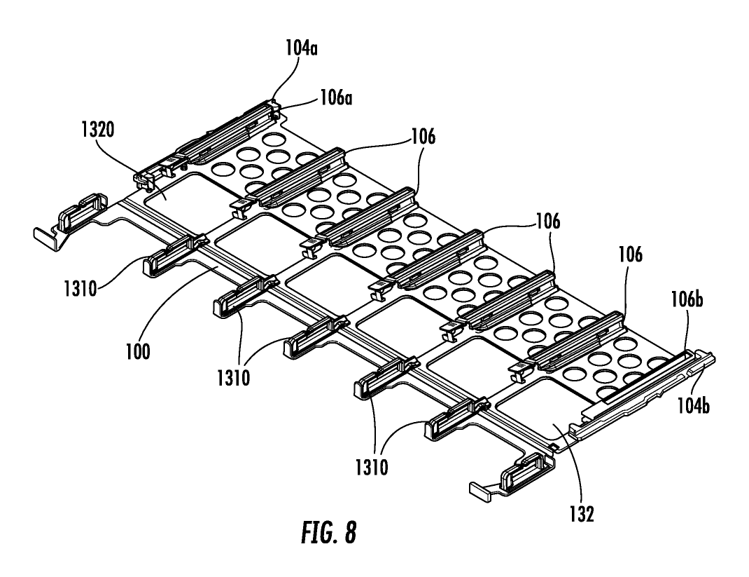

FIG. 8 illustrates tray 100 for mounting fiber optic equipment. Tray 100 may be mounted in a chassis as disclosed or other suitable equipment. “Mounting” as the term is used here, refers to any component or group of componenets suitable for permanenently, semi-permanently, temporarily, and/or removably coupling tray 100 to the chassis. According to one embodiment, “mounting” may be effectuated by securing the tray 100 to the chassis using a permanent or semi-permanent fastener such as, for example, rivets, bolts, screws, or any other suitable mechanism (or combinations thereof) for fastening one structure to another. Alternatively or additionally, “mounting” may include or embodiment temporary or non-permanent solutions for securing tray 100 to the chassis. For example, in certain exemplary embodiments, mounting may be effectuated using clips, pull-tabs, removable rivets, press-clips, pine-tree type clips, push-nut fasteners, or any other type of fastener suitable for removably coupling tray 100 to chassis. “Mounting” may also include or embody any component or combinations of components suitable for slidably coupling tray 100 to the chassis. For example, tray 100 may be mounted to the chassis by way of a guide rail coupled to the chassis that, when coupled to a corresponding rail component of tray 100, supports and guides tray 100, allowing for forward-rearward translation of tray 100 relative to chassis.

Tray 100 comprises a base for supporting a plurality of BASE-8 fiber optic equipment. For instance, the tray can include module and/or panel assembly. The tray comprises one or more support rails 104a, 104b of the base for movably mounting the tray 100 in a chassis. The tray also comprises a plurality of equipment support rails 106 of the base for movably mounting the plurality of BASE-8 fiber optic equipment to the tray 100. Support rails and/or the equipment support rails may be modular components or may be integrally formed with the base of the tray as desired.

Base is configured to support at least five (5) pieces of BASE-8 fiber optic equipment in a width direction. Tray 100 has a height of 1/3 U-Space or less. The tray may support a connection density of greater than thirty-two (32) fiber optic connections, at least forty (40) fiber optic connections, and forty-eight (48) fiber optic connections per 1/3 U-space with a BASE-8 configuration.

As depicted in FIG. 8, the tray is configured to support at least six pieces of BASE-8 fiber optic equipment equipment in the width W direction. Thus, module is configured to mount into tray 100 using 1/6 of the tray width W or less. The trays disclosed can be designed to be installable into existing installed base of chassis, thereby forming hybrid chassis having a first tray that supports BASE-8 fiber optic equipment and a second tray that supports BASE-12 fiber optic equipment.

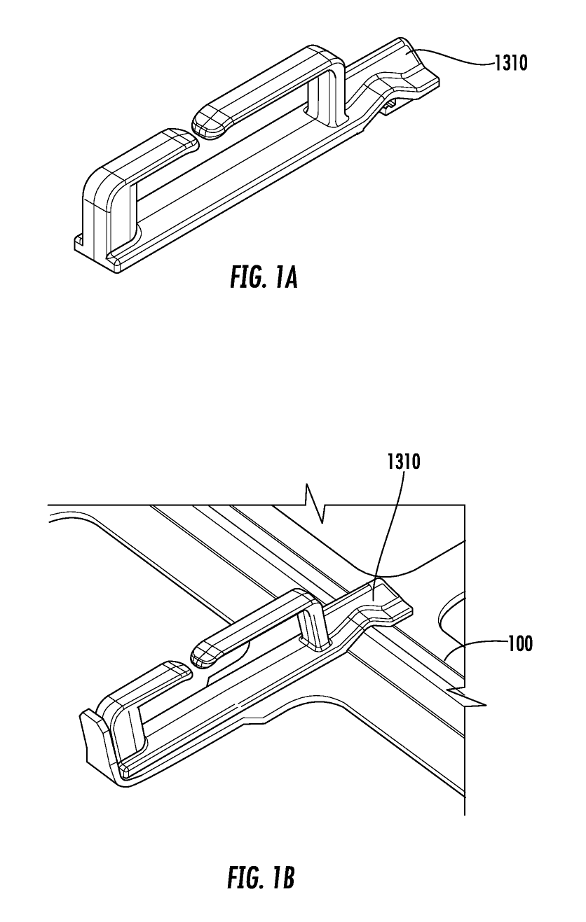

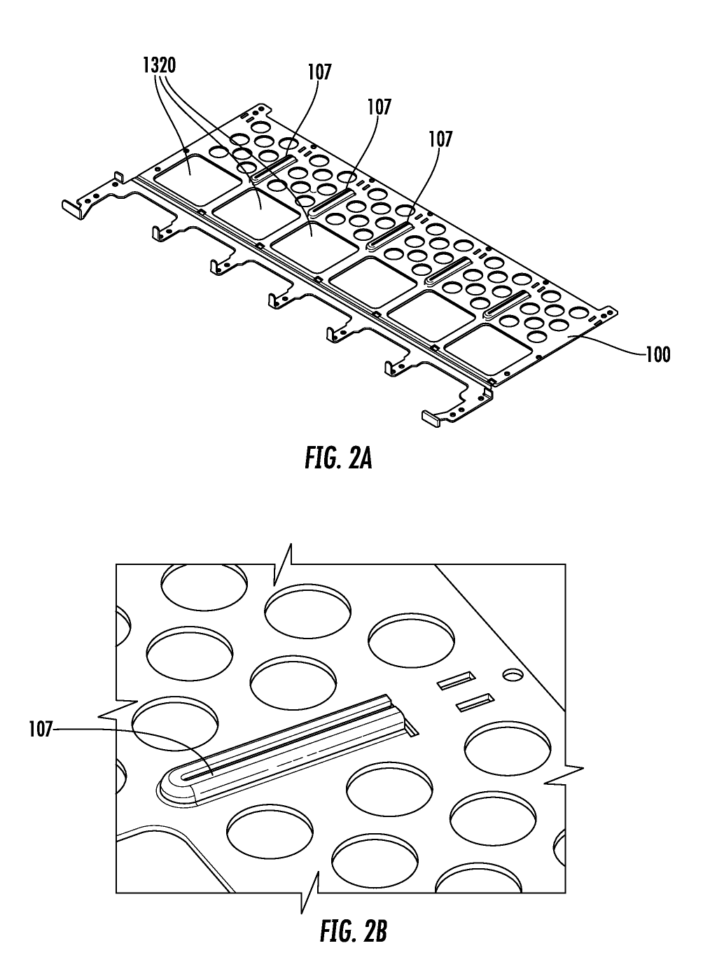

FIGS. 1A and 1B illustrate perspective views of an exemplary cable routing guide and said exemplary cable routing guide connected to an equipment tray, respectively, in accordance with certain disclosed embodiments. Similarly, FIGS. 2A and 2B illustrate features associated with equipment tray for toollessly attaching the tray and module rail guides, consistent with certain disclosed embodiments;

Tray 100 may be mounted in a chassis as disclosed or other suitable equipment. “Mounting” as the term is used here, refers to any component or group of componenets suitable for permanenently, semi-permanently, temporarily, and/or removably coupling tray 100 to the chassis. According to one embodiment, “mounting” may be effectuated by securing the tray 100 to the chassis using a permanent or semi-permanent fastener such as, for example, rivets, bolts, screws, or any other suitable mechanism (or combinations thereof) for fastening one structure to another. Alternatively or additionally, “mounting” may include or embodiment temporary or non-permanent solutions for securing tray 100 to the chassis. For example, in certain exemplary embodiments, mounting may be effectuated using clips, pull-tabs, removable rivets, press-clips, pine-tree type clips, push-nut fasteners, or any other type of fastener suitable for removably coupling tray 100 to chassis. “Mounting” may also include or embody any component or combinations of components suitable for slidably coupling tray 100 to the chassis. For example, tray 100 may be mounted to the chassis by way of a guide rail coupled to the chassis that, when coupled to a corresponding rail component of tray 100, supports and guides tray 100, allowing for forward-rearward translation of tray 100 relative to chassis.

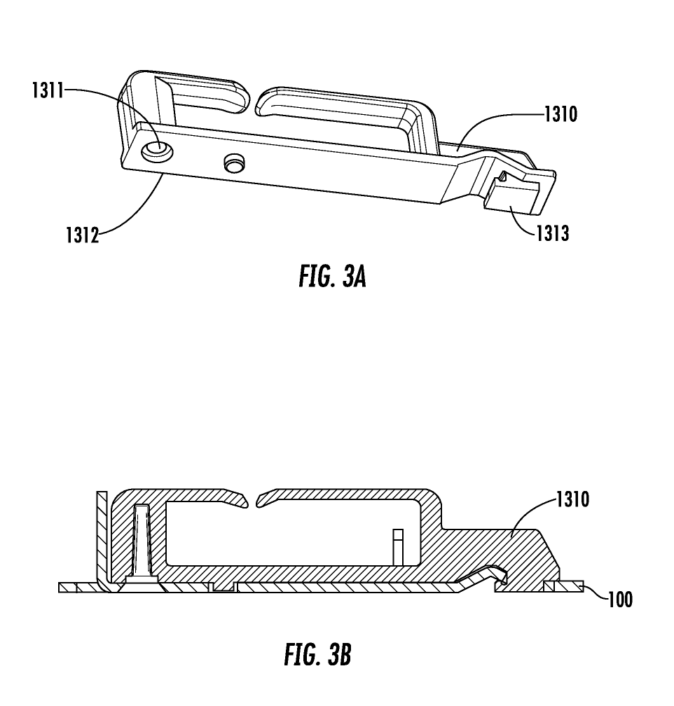

According to the embodiments shown in FIGS. 1A and 1B, various features of the tray assembly may be modularly and toollessly mounted to tray 100. For example, as illustrated in FIGS. 3A and 3B, cable routing features may include a clip-lock system 1312 that is designed to cooperate with features for receiving cable routing guides 1310 and locking cable routing guides into place, without requiring screws or requiring fewer tool-based fasterners than conventional modular systems.

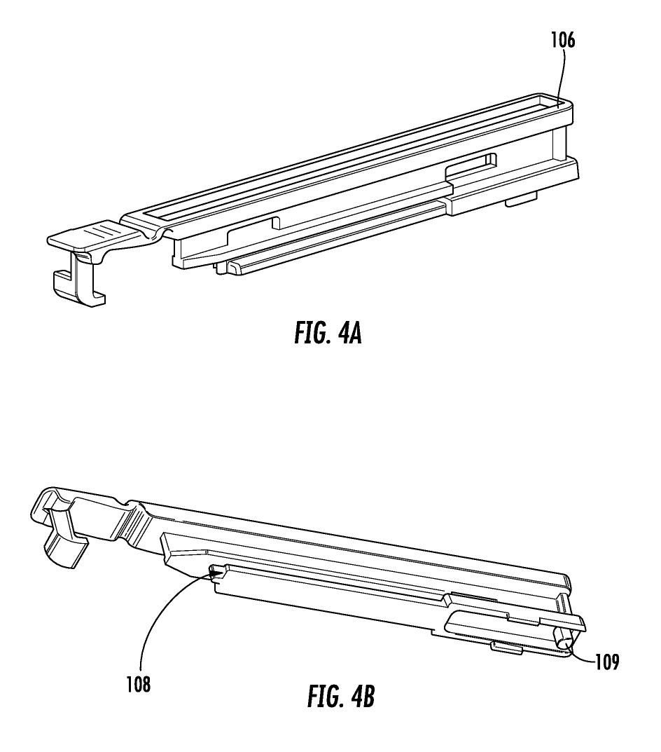

FIG. 2B illustrates a zoom-in, perspective front view of tray 100 with multiple features 107 for receiving a plurality of module guide features shown in FIGS. 4A and 4B. As illustrated in FIGS. 2A and 2B, tray 100 may include one or more access holes 1320. According to one embodiment, access holes 1320 may include or embody a rectangular opening in the bottom of the tray. In certain embodiments, access holes 1320 may be made wide enough to allow finger access to modules 10 from underneath tray, and to allow the shutters on panels to rotate open greater than 90 degrees. Access holes 1320 are sized to correspond with the footprint of BASE-8 modules and panels, but may be sized to support width of either hybrid panels or BASE-12 panels and BASE-8 simultaneously (or any combination thereof).

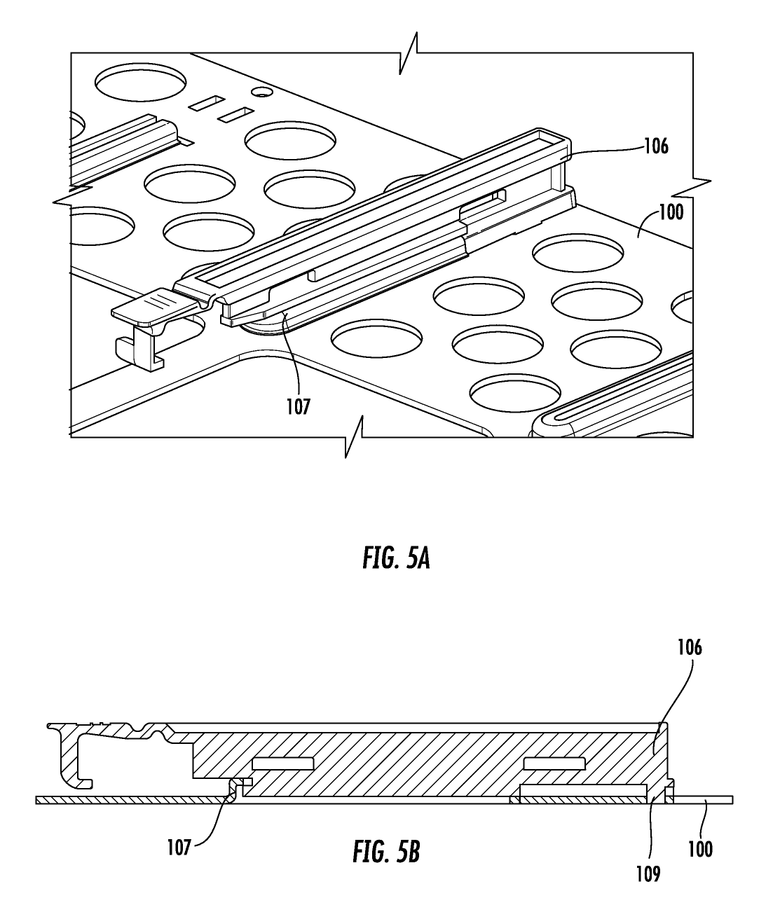

FIGS. 4A and 4B illustrate perspective views of an exemplary mounting rail 106 for use on a tray 100, in accordance with certain disclosed embodiments. FIGS. 5A and 5B illustrates a perspective view of an exemplary tray 100 equipped with the exemplary mounting rails 106 of FIGS. 4A and 4B, consistent with certain disclosed embodiments. As illustrated in the embodiment of FIG. 4A and 4B, the slide mount system of module rail 106 has a groove 108 and peg 109. According to the embodiment shown in FIG. 5A and 5B, groove 108 engages with corresponding slots 107 on tray 100 and slides into the tray. When the module rail is completely engages with slot 107 on tray 100, peg 109 engages a corresponding hole on tray 100 and locks the module rail into place.

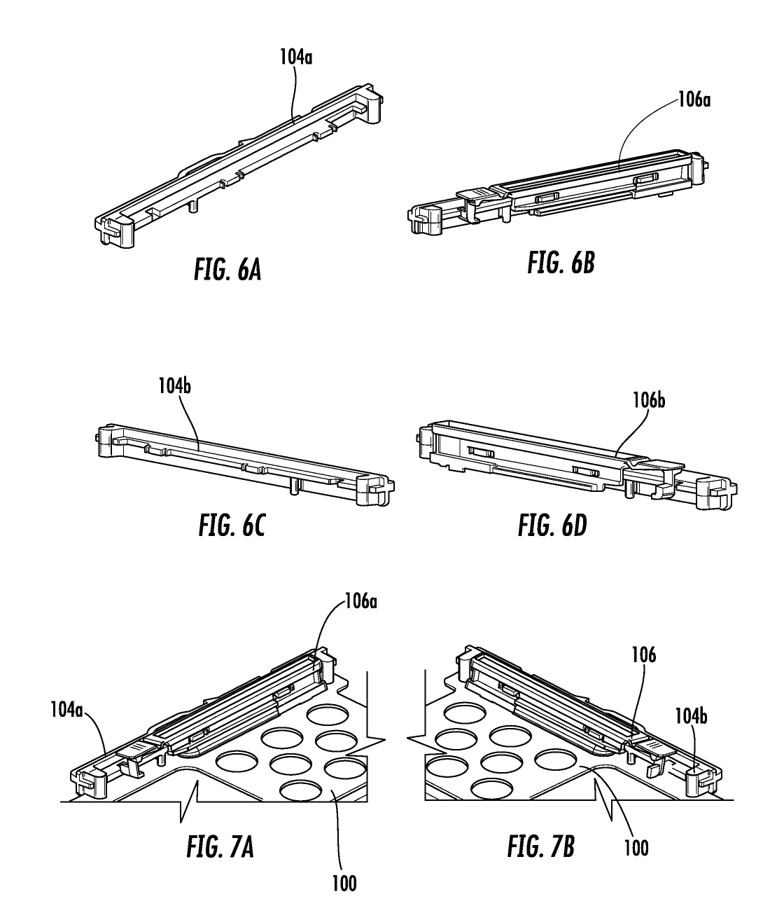

FIGS. 6A and 6B illustrate perspective views of an exemplary left tray rail and module mounting rails, toollessly attached to left tray rail, consistent with certain disclosed embodiments. FIGS. 6C and 6D illustrate perspective views of an exemplary right tray rail and module mounting rails, toollessly attached to right tray rail, consistent with certain disclosed embodiments. FIGS. 7A and 7B illustrate perspective views of an exemplary left and right tray rails, respectively, with module mounting rails toollessly attached to the respective left and right tray rails and toollessly connected to the equipment tray, consistent with certain disclosed embodiments.

FIG. 8 provides a view of the equipment trays, in accordance with certain disclosed embodiments. As shown in FIG. 8, tray 100 may include a plurality of routing guide support fingers (not separately numbered) that extend outwardly toward the front of tray 100 for supporting cable routing guides 1310. The metallic support structure of tray 100 corresponding to the routing guide support fingers is sized of thickness and length to provide for optimal hand and finger access to modules, panels, or other equipment associated with chassis. Similarly, the tray rail mounting support (not separately numbered) of tray 100, which extends toward the rear of the tray 100 from opposing lateral edges of tray 100, are also sized of thickness and length to allow access to the thumb release left rear and the finger tab right rear positions.

Unless otherwise expressly stated, it is in no way intended that any method set forth herein be construed as requiring that its steps be performed in a specific order. Accordingly, where a method embodiment does not actually recite an order to be followed by its steps or it is not otherwise specifically stated in the embodiments or descriptions that the steps are to be limited to a specific order, it is no way intended that any particular order be inferred.

It will be apparent to those skilled in the art that various modifications and variations can be made without departing from the spirit or scope of the disclosure. Since modifications combinations, sub-combinations and variations of the disclosed embodiments incorporating the spirit and substance of the disclosure may occur to persons skilled in the art, the disclosure should be construed to include everything within the scope of the appended embodiments and their equivalents.

We claim:

1. A tray for mounting fiber optic equipment, the tray comprising:
a base for supporting a plurality of BASE-8 fiber optic equipment;
one or more support rails of the base for movably mounting the tray in a fiber optic equipment chassis; and
a plurality of equipment support rails of the base for movably mounting the plurality of BASE-8 fiber optic equipment to the tray.

2. The tray of claim 1, wherein the BASE-8 fiber optic equipment is a module or a panel assembly.

3. The tray of claim 1, wherein the base is configured to support at least five (5) BASE-8 pieces of fiber optic equipment in a width direction.

4. The tray of claim 1, wherein the base is configured to support at least six (6) pieces of BASE-8 fiber optic equipment in a width direction.

5. The tray of claim 1, wherein the tray has a height of 1/3 U-space or less.

6. The tray of claim 1, wherein the tray supports a connection density of greater than thirty-two (32) fiber optic connections.

7. The tray of claim 1, wherein the tray supports a connection density of at least forty (40) fiber optic connections per 1/3 U-space.

8. The tray of claim 1, wherein the tray supports a connection density of forty-eight (48) fiber optic connections per 1/3 U-space.

9. The tray of claim 1, wherein the base is configured to support at least five (5) BASE-8 fiber optic equipment.

10. The tray of claim 1, wherein the base is configured to support at least six (6) BASE-8 fiber optic equipment.

11. The tray of claim 1, further comprising a fiber optic equipment chassis having a plurality of trays mounted therein and supporting a connection density of greater than ninety-six (96) fiber optic connections per one U-space.

12. The tray of claim 1, further comprising a fiber optic equipment chassis having a plurality of trays mounted therein and supporting a connection density of at least one hundred twenty (120) fiber optic connections per one U-space.

13. The tray of claim 1, further comprising a fiber optic equipment chassis having a plurality of trays mounted therein and supporting a connection density of at least one hundred forty-four (144) fiber optic connections per one U-space.

14. A fiber optic equipment comprising:
a front panel disposed at a front end of the fiber optic panel assembly;
a linear array of fiber optic adapters arranged in a width direction in the front panel in a BASE-8 configuration, wherein the fiber optic adapters are configured to support a plurality of optical fibers optically connected between the plurality of fiber optic adapters and a rear end of the fiber optic assembly;
wherein the fiber optic assembly is configured to mount into a tray using 1/6 of the tray width or less.

15. The fiber optic equipment of claim 14, the linear array of fiber optic adapters having LC ports.

16. The fiber optic equipment of claim 14, further comprising a housing extending between the front panel and the rear end of the fiber optic assembly.

17. The fiber optic equipment of claim 14, wherein the housing is an enclosure.

18. A fiber optic module comprising:
a housing having a front side;
a linear array of fiber optic adapters arranged in a width direction in the front side in a BASE-8 configuration, wherein the fiber optic adapters are configured to support a plurality of optical fibers optically connected between the fiber optic adapters and a rear side of the fiber optic assembly;
wherein the fiber optic module is configured to mount into a tray using 1/6 of the tray width or less.

19. The fiber optic module of claim 18, wherein the linear array of fiber optic adapters support eight LC connections.

20. The fiber optic module of claim 18, wherein the module has an adapter extending from the rear side.

21. The fiber optic module of claim 18, wherein the module has a pigtail extending from the rear side.
